(19) United States
(12) Patent Application Publication
(10) Pub. No.: US 2025/0186953 A1
(43) Pub. Date: Jun. 12, 2025

(54) SYSTEM AND METHOD FOR GAS BLADE MIXING OF BATTERY ELECTRODE SLURRIES

(71) Applicant: GM GLOBAL TECHNOLOGY OPERATIONS LLC, Detroit, MI (US)

(72) Inventors: Erik Damon HUEMILLER, Troy, MI (US); Wayne Cai, Troy, MI (US); Ming Wang, Sterling Heights, MI (US); Robin James, Rochester Hills, MI (US); Nicole Ellison, Southfield, MI (US)

(21) Appl. No.: 18/530,808

(22) Filed: Dec. 6, 2023

(51) Int. Cl. B01F 25/21; H01M 4/139

(52) U.S. Cl. CPC B01F 25/212; H01M 4/139

(57) ABSTRACT

A mixing device includes a source of pressurized gas and a mixing chamber. A gas blade nozzle is disposed within the mixing chamber and connected to the source of pressurized gas.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to a system and method for gas blade mixing of battery electrode slurries.

Mixing of a battery electrode slurry is an integral part of the battery manufacturing process. It is a time-consuming process which typically encompasses multiple slurry mixing steps to produce the final electrode slurry. It also requires a heavily involved equipment cleaning process between batches or if there is ever a change in chemistry. This generates a lot of waste including excess raw material/slurry consumption. Current mixing processes use fixed geometry mechanical mixing blades. These are inflexible and require an extended time to clean. Accordingly, an improved system and method for mixing battery electrode slurries is needed.

### SUMMARY

According to an aspect of the present disclosure, a mixing device includes a source of pressurized gas and a mixing chamber. A gas blade nozzle is disposed within the mixing chamber and connected to the source of pressurized gas.

According to a further aspect, a directional adjustment mechanism movably supports the at least one gas blade nozzle.

According to a further aspect, a directional adjustment mechanism rotatably supports the at least one gas blade nozzle.

According to a further aspect, the gas blade nozzle includes a plurality of gas blade nozzles.

According to a further aspect, at least one of the plurality of gas blade nozzles is directed at a sidewall of the mixing chamber.

According to a further aspect, at least one of the plurality of gas blade nozzles is directed at a bottom of the mixing chamber.

According to a further aspect, a mixing blade within the mixing chamber and drivingly connected to a drive system.

According to a further aspect, the at least one gas blade nozzle is directed at the mixing blade to clean the mixing blade.

According to a further aspect, the at least one gas blade nozzle is formed within the mixing blade.

According to a further aspect, an exit port of the at least one gas blade nozzle includes a plug for filling the exit port when the nozzle is closed.

According to a further aspect, a vacuum line is in communication with the mixing chamber.

According to a further aspect, the vacuum line includes a liquid separator to collect solvent and drain it back into the mixing chamber.

According to a further aspect, the source of pressurized gas includes one of air and inert gases.

According to a further aspect, the source of pressurized gas has a temperature control system for heating the pressurized gas.

According to a further aspect, the source of pressurized gas has a temperature control system for cooling the pressurized gas.

According to a further aspect, the at least one gas blade nozzle is a variable area nozzle.

According to a further aspect, the at least one gas blade nozzle is mounted to a flexible tube.

According to another aspect, a mixing device includes a source of pressurized gas and a mixing chamber. A plurality of gas blade nozzles are disposed within the mixing chamber and connected to the source of pressurized gas.

According to a further aspect, at least one of the plurality of gas blade nozzles is directed at a sidewall of the mixing chamber.

According to a further aspect, a directional adjustment mechanism movably supports the plurality of gas blade nozzles.

The disclosed system and method for gas blade mixing of battery electrode slurries can eliminate the complexity of the fixed geometry blades and enables more flexible mixing protocols with gas blades. Additionally, it can be utilized with existing technology to decrease mixing times and reduce cleaning/waste generation. The mixing system also enables more tailored mixing protocols by increasing the flexibility of the mixing processes with nozzle flow control and novel nozzle designs to further optimize shear forces within the mixer.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic view of a gas blade mixer according to the principles of the present disclosure;

FIG. 2 is a schematic view of a hybrid gas blade/mechanical mixer according to the principles of the present disclosure;

FIG. 3 is a schematic view of a vacuum pump system for evacuating air from the mixing container during use of a gas blade system;

FIG. 4A is a schematic view of a self-cleaning gas blade nozzle design shown in an open position;

FIG. 4B is a schematic view of the self-cleaning gas blade nozzle design shown in a closed position;

FIG. 5A is a schematic view of a self-cleaning gas blade nozzle design shown in an open position;

FIG. 5B is a schematic view of the self-cleaning gas blade nozzle design shown in a closed position;

FIG. 6 is a schematic view of a drive mechanism for moving the gas blade nozzles according to the principles of the present disclosure; and

FIG. 7 is a schematic view of a mixing blade with the gas blade nozzles incorporated therein.

In the drawings, reference numbers may be reused to identify similar and/or identical elements.

### DETAILED DESCRIPTION

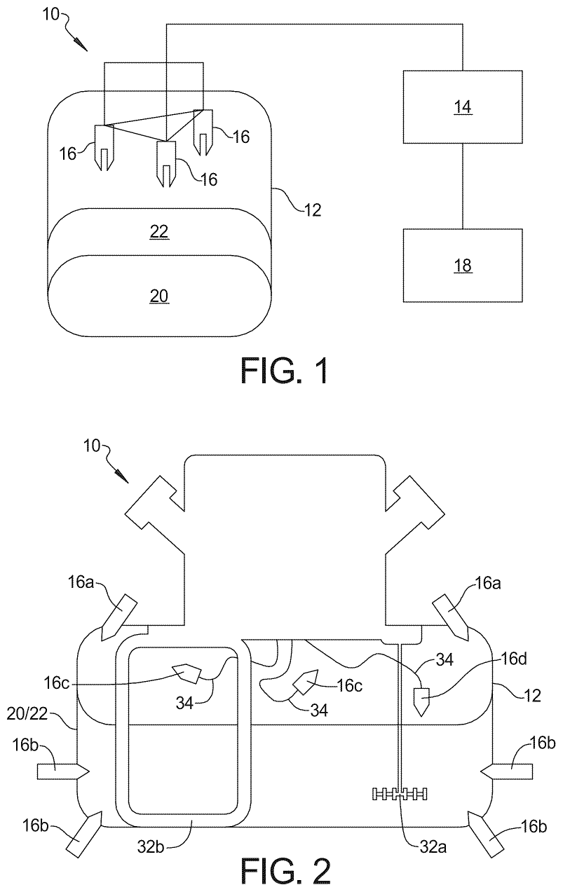

With reference to FIG. 1, a mixing device 10 according to the principles of the present disclosure will now be described. The mixing device 10 includes a mixing chamber 12 and a pressurized gas source 14. A plurality of gas blade nozzles 16 are disposed in the mixing chamber 12 and connected to the pressurized gas source 14. The pressurized gas source 14 can include air or an inert gas. The pressurized gas source 14 can optionally include a temperature control system 18. Depending upon the slurry that is being mixed, the temperature control system 18 can either heat or cool the pressurized gas. The gas blade nozzles 16 are used to mix two or more components 20, 22 of a mixture. The gas blade nozzles 16 can direct an air stream that can have various forms selected for mixing the slurry components. For example, the air stream can have a linear shape, an arcuate shape and a spot shape.

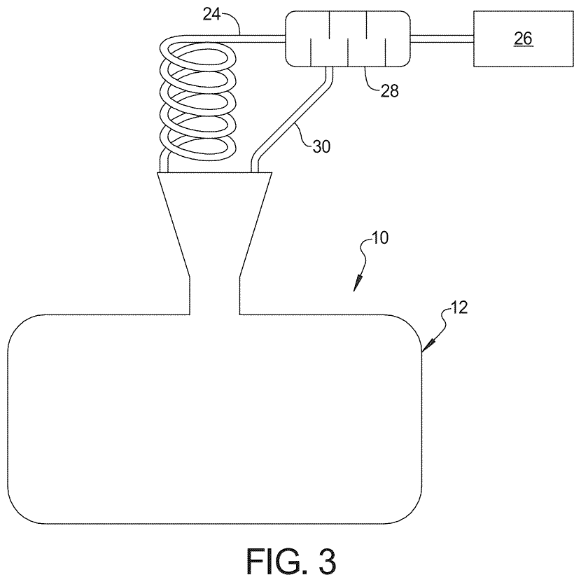

With reference to FIG. 3, the mixing device can include a vacuum line 24 in communication with the mixing chamber 12 and connected to a vacuum source 26. The vacuum line 24 is operable with the gas blade nozzles 16 to withdraw the air that is introduced to the mixing chamber 12. The vacuum line 24 can further include a liquid separator 28 that can separate liquids from the vacuum line 24 and return them to the mixing chamber 12 via the liquid return line 30.

With reference to FIG. 2, the gas blade nozzles 16 can be used in combination with one or more conventional mixing blades 32a, 32b. As shown in FIG. 2, one or more of the gas blade nozzles 16a can be directed at the sidewall of the mixing chamber 12 to clean the slurry off of the mixing chamber sidewalls. Additional gas blade nozzles 16b can extend through the sidewalls to introduce pressurized gas directly into the slurry. In addition, additional gas blade nozzles 16c can be mounted to flexible hoses 34 that direct pressurized gas randomly within the mixing chamber 12. An additional gas blade nozzle 16d can be directed at the mixing blade 32a and can be used to clean slurry off of the mixing blade 32a.

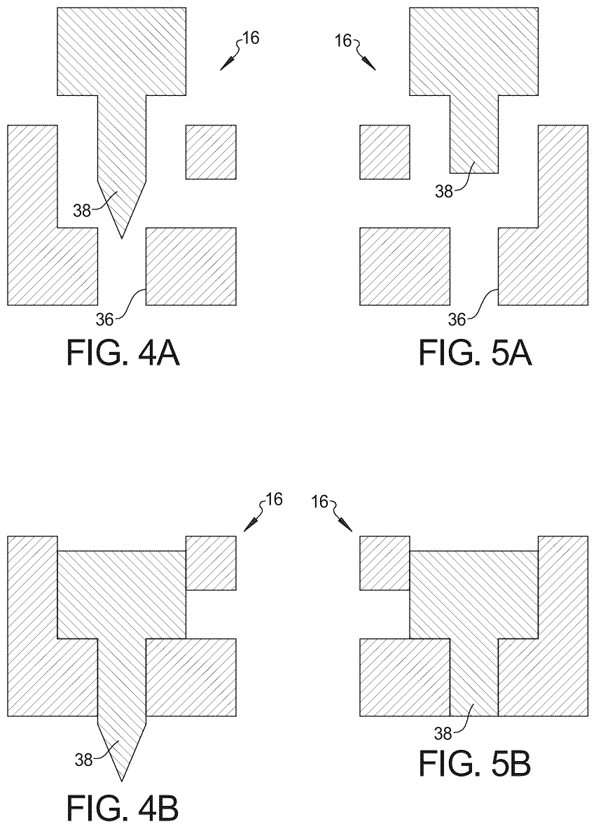

With reference to FIGS. 4A and 4B, the gas blade nozzles 16 can include a self-cleaning design in which the nozzle openings 36 are blocked by a plug 38 that can have a pointed tip. Alternatively, as shown in FIGS. 5A and 5B, the plug 38 can have a blunt tip. The plug 38 can fill the hole when the nozzle is closed so that debris in the gas blade nozzle 16 can be mechanically cleaned out when the nozzle 16 is turned off. By controlling the position of the plug 38 relative to the opening, the gas blade nozzle 16 can be varied to provide alternative intensity and direction.

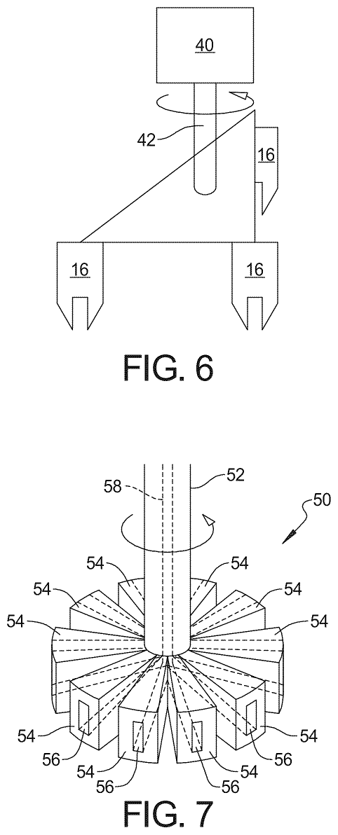

With reference to FIG. 6, the gas blade nozzles 16 are shown mounted to a drive mechanism 40 that rotates a spindle 42 that rotatably supports the nozzles 16. The speed of rotation of the spindle 42 can be controlled to provide optimal mixing.

With reference to FIG. 7, the gas blade nozzles 56 can be incorporated directly into a mixing blade 50. The spindle 52 and the blades 54 can each have an internal air passage 58 that open to a plurality of gas blade nozzles 56. The mixing blade can be made by 3-D printing or formed from multiple pieces.

The present disclosure includes a novel mixer design using air nozzles that create and control gas blades in the mixing vessel to reduce equipment complexity. The disclosure also includes process improvements that can replace or augment current processes with gas blades. This could eliminate the mechanical mixing step completely by using gas blades for both wet and dry mixing or it could be used with existing processes. These improvements could speed up slurry mixing, reduce cleaning time, and curb slurry material waste generated. This present disclosure can reduce the complexity of the mixing equipment, reduce the time to clean the parts between mixing batches, reduce overall mixing times, and improve the uniformity of the slurries after mixing. The gas blades could be used for high shear mixing or low shear mixing depending on nozzle and process design.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

What is claimed is:

1. A mixing device comprising:
a source of pressurized gas;
a mixing chamber; and
at least one gas blade nozzle disposed within the mixing chamber and connected to the source of pressurized gas.

2. The mixing device according to claim 1, further comprising a directional adjustment mechanism movably supporting the at least one gas blade nozzle.

3. The mixing device according to claim 1, further comprising a directional adjustment mechanism rotatably supporting the at least one gas blade nozzle.

4. The mixing device according to claim 1, wherein the gas blade nozzle includes a plurality of gas blade nozzles.

5. The mixing device according to claim 4, wherein at least one of the plurality of gas blade nozzles is directed at a sidewall of the mixing chamber.

6. The mixing device according to claim 4, wherein at least one of the plurality of gas blade nozzles is directed at a bottom of the mixing chamber.

7. The mixing device according to claim 1, further comprising a mixing blade within the mixing chamber and drivingly connected to a drive system.

8. The mixing device according to claim 7, wherein the at least one gas blade nozzle is directed at the mixing blade to clean the mixing blade.

9. The mixing device according to claim 7, where the at least one gas blade nozzle is formed within the mixing blade.

10. The mixing device according to claim 1, wherein an exit port of the at least one gas blade nozzle includes a plug for filling the exit port when the nozzle is closed.

11. The mixing device according to claim 1, further comprising a vacuum line in communication with the mixing chamber.

12. The mixing device according to claim 11, wherein the vacuum line includes a liquid separator to collect solvent and drain it back into the mixing chamber.

13. The mixing device according to claim 1, wherein the source of pressurized gas includes one of dry air, argon, and nitrogen.

14. The mixing device according to claim 1, wherein the source of pressurized gas has a temperature control system for heating the pressurized gas.

15. The mixing device according to claim 1, wherein the source of pressurized gas has a temperature control system for cooling the pressurized gas.

16. The mixing device according to claim 1, wherein the at least one gas blade nozzle is a variable area nozzle.

17. The mixing device according to claim 1, wherein the at least one gas blade nozzle is mounted to a flexible tube.

18. A mixing device comprising:
a source of pressurized gas, wherein the source of pressurized gas includes one of dry air, argon, and nitrogen;
a mixing chamber; and
a plurality of gas blade nozzles disposed within the mixing chamber and connected to the source of pressurized gas.

19. The mixing device according to claim 18, wherein at least one of the plurality of gas blade nozzles is directed at a sidewall of the mixing chamber.

20. The mixing device according to claim 18, further comprising a directional adjustment mechanism movably supporting the plurality of gas blade nozzles.
